(19) United States
(12) Patent Application Publication
(10) Pub. No.: US 2016/0169771 A1
(43) Pub. Date: Jun. 16, 2016

(54) Condition Monitoring Apparatus

(71) Applicant: HITACHI, LTD., Chiyoda-ku, Tokyo (JP)

(72) Inventors: Tomoaki HIRUTA, Tokyo (JP); Hideaki SUZUKI, Tokyo (JP); Junsuke FUJIWARA, Tokyo (JP); Takayuki UCHIDA, Tokyo (JP)

(21) Appl. No.: 14/392,158

(22) PCT Filed: Jun. 24, 2013
(86) PCT No.: PCT/JP2013/067169

§ 371 Date: Dec. 23, 2015

(51) Int. Cl. G01M 99/00; G01M 15/14

(52) U.S. Cl. CPC G01M 99/005; G01M 15/14

(57) ABSTRACT

The present invention relates to a condition monitoring apparatus for monitoring a machine condition. According to the present invention, the diagnosis accuracy can be improved as reducing dependence on technical knowledge about the machine. The condition monitoring apparatus that diagnosis an abnormal state of a machine based on machine operation data acquired from a plurality of sensors. The condition monitoring apparatus includes a data collection unit configured to collect a plurality pieces of sensor data of the machine, a diagnosing unit configured to acquire a sensor data group at a predetermined time from the sensor data and a data storage unit that stores a diagnostic model that is a requirement to diagnose an abnormal state of the machine, and diagnose the abnormal state of the diagnosed machine based on the diagnostic model, a first distribution creation unit configured to create first distribution that is data frequency of each sensor based on the sensor data group aggregated with the total number of bins or a width which is previously set according to the machine performance, a second distribution creation unit configured to extract sensor data from the sensor data group at a time when the diagnosing unit diagnoses the abnormal state and create second distribution that is frequency of extracted data of each sensor aggregated with the total number of bins or width which is same as that of the first distribution, a display unit configured to display, on a screen, the first distribution and the second distribution of each sensor, an input unit to which a user inputs a new diagnostic model, and an update unit configured to write the new diagnostic model to the data storage unit.

### TECHNICAL FIELD

The present invention relates to a condition monitoring apparatus for monitoring a machine condition.

### BACKGROUND ART

Working machines that work in mines such as an excavator or a dump truck and machines for social infrastructure such as a gas turbine for power generation are required to operate twenty-four hours a day. To maintain high operation rates of those machines, it is important to prevent the machines from unexpected stoppage. In this point of view, it is required to shift from conventional periodical maintenance based on the operation time of the machine to condition monitoring maintenance that properly performs preventive maintenance based on machine conditions. To realize the condition monitoring maintenance, it is important to diagnose, with a condition monitoring apparatus, a predictor of a machine abnormality or a failure by collecting and analyzing sensor data from various sensors provided to the machine. To improve the diagnostic accuracy of the condition monitoring apparatus, it is important that an engineer keeps periodically updating a diagnostic model so that false reports and false negative in diagnoses can be reduced. The false report is a case of diagnosing a machine normal state as an abnormal condition. The false negative is a case of diagnosing a machine abnormal state as a normal condition. Further, the diagnostic model is sensor data used in diagnosing, a diagnostic method, and determination requirements. For example, the determination requirements may be a threshold value of a corresponding sensor data.

There is a technique for updating a diagnostic model to improve the diagnostic accuracy, for example, PTL 1. PTL 1 discloses a process abnormality diagnosing apparatus including a prior information generation unit 51 for generating prior information related to a ratio between abnormal data and normal data included in statistic data, a threshold value determination unit 52 for determining a threshold value used to determine an abnormal condition and a normal condition of statistic data based on the prior information, and an abnormality diagnosing unit 7 for diagnosing abnormal state of the target process by using the threshold value and the statistic data.

### CITATION LIST

### Patent Literature

PTL 1: Japanese Patent Application Laid-Open No. 2008-59270

### SUMMARY OF INVENTION

### Technical Problem

PTL 1 discloses a method for setting a threshold value for determination. However, since this method does not consider the machine conditions, the diagnostic accuracy is reduced. The machine conditions are divided into a steady state in which the machine is being steady and a transient state before the steady state. For example, an engine is in a transient state of unstable operation since the engine is not heated enough just after activated, but becomes in a steady state after a certain period of time passes. When the method of PTL 1 is applied to all the machine conditions, it is more likely that more false positives are found in diagnosis in transient states.

Therefore, when the machine steady states are divided based on sensor data before diagnosing, this helps to improve the accuracy. This extraction of the machine steady states is referred to as a condition division. For condition division, a sensor and a requirement thereof to divide conditions need to be set. The sensor and the requirement thereof to divide conditions are defined as a condition division requirement. This condition division requirement is also a part of the diagnostic model. For example, to extract a steady state of an engine, a condition division requirement that an engine oil temperature sensor is equal to or greater than 60° C. is employed. However, for the setting of the condition division requirement, technical knowledge related to the machine is necessary. With the machine technical knowledge, a sensor used to divide the conditions can be selected from many sensors and determine the requirement thereof. Thus, there is a problem that only a machine specialist can create a diagnostic model.

The present invention is made to solve the above problem and has an object to provide a condition monitoring apparatus that can create a high accuracy diagnostic model by creating a requirement to extract conditions of a diagnostic target machine, as reducing dependence on technical knowledge related to the machine.

### Solution to Problem

To achieve the object, a condition monitoring apparatus according to the present invention diagnoses an abnormal state of a machine based on operation data of the machine acquired via a plurality of sensors and the condition monitoring apparatus includes a data collection unit configured to collect a plurality of pieces of sensor data of the machine, a diagnosing unit configured to acquire a sensor data group at a predetermined time from the sensor data and a data storage unit that stores a diagnostic model that is a requirement to diagnose an abnormal state of the machine, and diagnose the abnormal′ state of the diagnosed machine based on the diagnostic model, a first distribution creation unit configured to create first distribution that is data frequency of each sensor based on the sensor data group aggregated with the total number of bins or a width which is previously set according to the machine performance, a second distribution creation unit configured to extract sensor data from the sensor data group at a time when the diagnosing unit diagnoses the abnormal state and create second distribution that is frequency of extracted data of each sensor aggregated with the total number of bins or width which is same as that of the first distribution, a display unit configured to display, on a screen, the first distribution and the second distribution of each sensor, an input unit to which a user inputs a new diagnostic model, and an update unit configured to write the new diagnostic model to the data storage unit.

Further, in the condition monitoring apparatus according to the present invention, the diagnostic model includes a sensor group used to diagnoses, an diagnostic algorithm to be used, a condition division requirement including sensor data for extracting a condition of the diagnostic target machine and a threshold value requirement of the sensor data, and a determination requirement that is a threshold value as an index to express an abnormal state level calculated by the diagnostic algorithm.

Further, the condition monitoring apparatus according to the present invention further includes a preprocessing unit for display configured to calculate a degree of difference between the first distribution and the second distribution for each sensor and set priority orders of the sensors in descending order of the degree of difference, and the display unit displays sensor names or the first distribution and the second distribution in order of the priority.

Further, in the condition monitoring apparatus according to the present invention, the preprocessing unit for display calculates a difference between the first distribution and the second distribution of each bin and calculates accumulated error rates in ascending order or descending order of the value corresponding to the bin, and the display unit displays the accumulated error rates with the first distribution and the second distribution.

Further, in the condition monitoring apparatus according to the present invention, the preprocessing unit for display calculates a difference between the first distribution and the second distribution of each bin, calculates accumulated error rates in ascending order or descending order of the value corresponding to the bin, compares the accumulated error rates with a requirement which is previously set according to sensor performance, sets a condition division requirement of the new diagnostic model based on the value corresponding to the bin corresponding to the requirement, and displays, on the display unit, the condition division requirement.

Further, in the condition monitoring apparatus according to the present invention, the display unit displays the time-series data of the sensors and highlights a part corresponding to the condition division requirement calculated by the preprocessing unit for display.

Further, in the condition monitoring apparatus according to the present invention, the display unit displays a diagnosis by the diagnosing unit where the condition division requirement by the preprocessing unit for display is applied as the new diagnostic model.

Further, in the condition monitoring apparatus according to the present invention, the display unit displays time-series data of the sensors and highlights a part corresponding to the condition division requirement of the new diagnostic model which is input by the input unit.

Further, in the condition monitoring apparatus according to the present invention, the display unit displays the diagnosis by the diagnosing unit where the new diagnostic model input by the input unit is applied.

### Advantageous Effects of Invention

According the present invention, since frequency distribution (first distribution) of sensor data of a machine and frequency distribution (second distribution) of sensor data of the machine in an abnormal state are displayed in comparison, options of sensors appropriate for condition division requirements of the diagnostic model can be narrowed down and this improves the accuracy of machine diagnoses.

### BRIEF DESCRIPTION OF DRAWINGS

FIG. 1 is a schematic diagram illustrating an information flow of a condition monitoring apparatus 100.

FIG. 2 is a block diagram of the condition monitoring apparatus 100.

FIGS. 3A to 3C are detail views of a storage unit 120 of the condition monitoring apparatus 100.

FIG. 4 is a flowchart illustrating a processing procedure of a diagnosing unit 130 of the condition monitoring apparatus 100.

FIG. 5 is a diagram illustrating an illustrative example of a data format of a diagnosis output from the diagnosing unit 130.

FIG. 6 is a flowchart illustrating a processing procedure of a first distribution creation unit 140 of the condition monitoring apparatus 100.

FIG. 7 is a flowchart illustrating a processing procedure of a second distribution creation unit 150 of the condition monitoring apparatus 100.

FIGS. 8A and 8B are diagrams illustrating an illustrative example of a data format of output results of the first distribution creation unit 140 and the second distribution creation unit 150 of the condition monitoring apparatus 100.

FIG. 9 is a flowchart illustrating a processing procedure of a priority order calculation unit 160 of the condition monitoring apparatus 100.

FIG. 10 is a diagram illustrating an illustrative example of a data format of a process result of the priority order calculation unit 160 of the condition monitoring apparatus 100.

FIG. 11 is a diagram illustrating an illustrative example of a screen 1 on a display unit 170 of the condition monitoring apparatus 100.

FIG. 12 is a diagram illustrating an illustrative example of a screen 2 on the display unit 170 of the condition monitoring apparatus 100.

FIG. 13 is a diagram illustrating an illustrative example of a screen 3 on the display unit 170 of the condition monitoring apparatus 100.

FIG. 14 is a flowchart illustrating a processing procedure of a comparison unit 180 of the condition monitoring apparatus 100.

FIG. 15 is a flowchart illustrating a processing procedure of a study unit 200 of the condition monitoring apparatus 100.

FIG. 16 is a flowchart illustrating a processing procedure of a modification example of the priority order calculation unit 160 of the condition monitoring apparatus 100.

FIG. 17 is a diagram illustrating illustrative examples of first probability distribution, second probability distribution, and an accumulated error rate which are calculated in the modification example of the priority order calculation unit 160 of the condition monitoring apparatus 100.

FIG. 18 is a diagram illustrating an illustrative example of a data format of a result calculated in the modification example of the priority order calculation unit 160 of the condition monitoring apparatus 100.

FIG. 19 is a diagram illustrating an illustrative example of a modification example of the screen 3 on the display unit 170 of the condition monitoring apparatus 100.

FIG. 20 is a diagram illustrating a relation between a vehicle 1000 and the condition monitoring apparatus 100.

FIG. 21 is a diagram illustrating a relation between a construction machine 2000 and the condition monitoring apparatus 100.

FIG. 22 is a diagram illustrating a relation between medical equipment 3000 and the condition monitoring apparatus 100.

### DESCRIPTION OF EMBODIMENTS

Embodiments that the present invention is applied to an apparatus for monitoring a machine condition will be described with reference to the accompanied drawings.

### First Embodiment

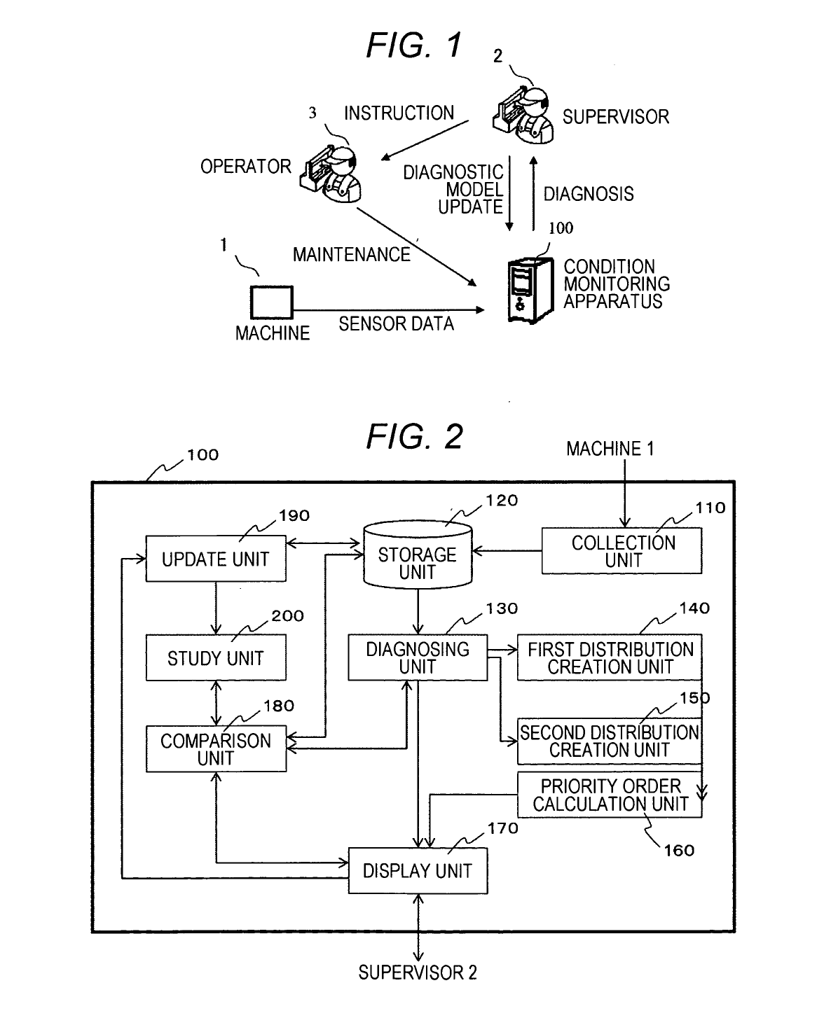

FIG. 1 is a diagram illustrating an information flow between a machine 1 as a monitoring target, a condition monitoring apparatus 100, a supervisor 2, and an operator 3.

As illustrated in FIG. 1, the condition monitoring apparatus 100 periodically collects sensor data of the machine 2 via a wired or wireless communication system (not shown). The machine 1 has various types of sensors (not shown). The supervisor 2 uses the condition monitoring apparatus 100 to monitor the machine condition remotely from the machine 1. Further, when the condition monitoring apparatus 100 diagnoses an abnormal state of the machine, the supervisor 2 contacts with the operator 3 in the field of the machine 2 to instruct to maintain the machine 2.

The condition monitoring apparatus 100 has a screen to display information related to a diagnosis of the machine 1 and the supervisor 2 monitors the condition of the machine 1 as looking at this screen. When an abnormal state often occurs in the diagnosis of a particular machine 1 for example, the supervisor 2 looks at the screen and determines whether a diagnostic model is set appropriately. When determining that the diagnostic model is not set appropriately, the supervisor 2 redefines the diagnostic model of the corresponding machine 1 via the screen of the condition monitoring apparatus 100. Then, the condition monitoring apparatus 100 updates the stored diagnostic model with the newly set diagnostic model.

Next, a detailed configuration of the condition monitoring apparatus 100 used in a condition monitoring system according to an embodiment of the present invention will be described with reference to FIG. 2. As illustrated in FIG. 2, the condition monitoring apparatus 100 is mainly composed of a collection unit 110, a storage unit 120, a diagnosing unit 130, a first distribution creation unit 140, a second distribution creation unit 150, a priority order calculation unit 160, a display unit 170, a comparison unit 180, an update unit 190, and a study unit 200. The collection unit 110, the storage unit 120, the diagnosing unit 130, the first distribution creation unit 140, the second distribution creation unit 150, the priority order calculation unit 160, the comparison unit 180, the update unit 190, and the study unit 200 are a microprocessor or a software processor, which is executed by a RAM or a ROM (not shown), mounted in the condition monitoring apparatus 100. The storage unit 120 is a storage device such as a hard disk, a flash memory or the like. The display unit 170 is a display screen such as a liquid crystal display.

The collection unit 110 is connected to the machine 1 via a wired or wireless communication system (not shown), collects data of various sensors of the machine 1, and writes the data to the storage unit 120. The collection unit 110 collects the sensor data at a predetermined timing.

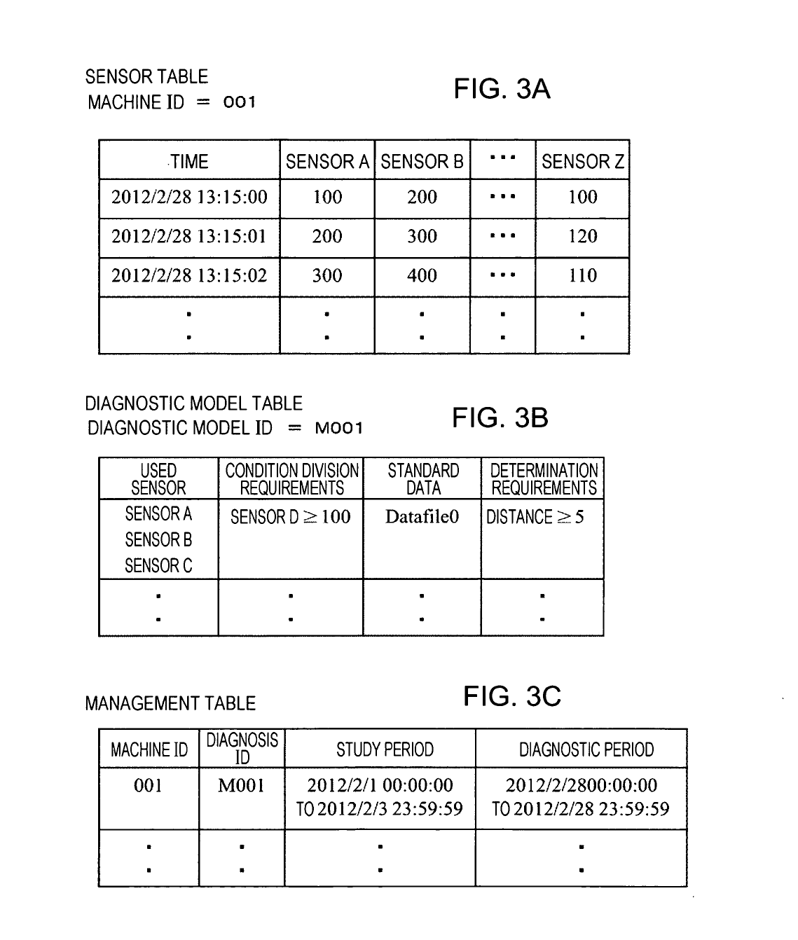

The storage unit 120 is composed of a sensor table (FIG. 3 (a)) that stores sensor data of the machine provided from the collection unit 110, a diagnostic model table (FIG. 3(b)) that stores a diagnostic model provided from the study unit 200, and a management table (FIG. 3(c)) that manages diagnoses. The details of each table will be described.

FIG. 3(a) illustrates details of the sensor table. The sensor table is created for each ID that identifies a machine (machine ID). The machine ID is a unique ID that is defined in the condition monitoring apparatus 100 to identify a machine (for example, 001, 002, 003 . . . ). FIG. 3(a) illustrates an example of a sensor table of machine ID 001. This sensor table stores time when each sensor has acquired data and a value of each sensor at the timing.

FIG. 3(b) illustrates details of the diagnostic model table. The diagnostic model table is created for each ID that identifies a diagnostic model (diagnostic model ID). The diagnostic model ID is a unique ID that is defined in the condition monitoring apparatus 100 to identify a diagnostic model (for example, M001, M002, M003 . . . ). The diagnostic model table of FIG. 3(b) illustrates a diagnostic model of a diagnostic model of which ID is M001.

In the diagnostic model table, a listing of used sensors stores at least one or more name of sensors used in diagnosis. In the diagnostic model M001, as used sensors, a sensor A, a sensor B, and a sensor C are stored. The diagnostic model of the diagnostic model M001 is assumed to be “k-means clustering” which is a multivariate analysis using more than one pieces of sensor data. K-means clustering is a method of data classification in which multivariate data is classified without training data. When this method is used, each of input data is considered as a point in a multivariate space and a cluster of data can be found based on a closeness of Euclidean distance between the points.

In the diagnostic model table, a listing of condition division requirements stores condition division requirements of the diagnostic model. In the diagnostic model M001, a condition division requirement that “a sensor D is equal to or greater than 100” is stored. The condition division requirements may be composed of requirements for a plurality of pieces of sensor data. Further, when there is no condition division requirement, “not applicable” is stored.

In the diagnostic model table, a listing of standard data stores data used as a standard in the diagnosis. The diagnostic model M001 is a diagnostic method that classifies data of the sensor A, the sensor B, and the sensor C into clusters by “k-means clustering.” In this case, datafile0 stored as the standard data stores information of a cluster which is previously calculated from time-series data of the sensor A, the sensor B, and the sensor C in normal conditions. The standard data is provided from the study unit 200.

In the diagnostic model table, a listing of determination requirements stores a determination requirements used to determine an abnormality by comparing diagnostic data and standard data. The diagnostic model M001 stores a requirement of Euclidean distance between diagnostic data and a cluster and, when Euclidean distance is equal to or greater than five, it is determined as an abnormal state.

The diagnostic model in FIG. 3(b) illustrates the diagnostic method with “k-means clustering” using a plurality of sensors; however, the diagnostic method is not limited to this method. Further, a model that determines an abnormality by comparing data from a single sensor, instead of more than one sensors, with a threshold value may be employed. In this case, the listing of the standard data is blank and the listing of the determination requirements stores determination requirements with the threshold value.

FIG. 3(c) illustrates details of the management table. The management table includes listings of machine IDs, learning periods, diagnostic periods, and diagnostic model IDs. The management table is created for each machine ID and diagnostic model ID. By using the management table, the machine and the diagnostic model can be corresponded to each other. Further, the diagnostic period processed in the diagnosing unit 130 and the learning period processed in the study unit 200 can be referred in the management table. The management table is reviewed by the supervisor 2 at a predetermined timing.

The diagnosing unit 130 performs a machine abnormality diagnosis of each machine and each diagnostic model based on data stored in the storage unit 120.

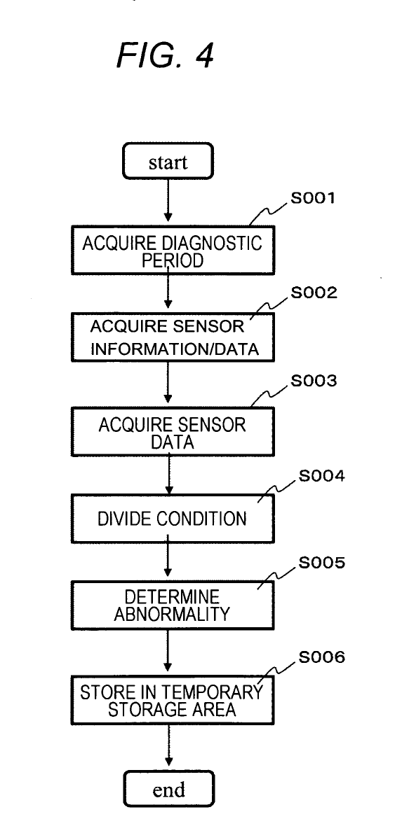

FIG. 4 illustrates a process flow of the diagnosing unit 130. This process flow is executed at a predetermined timing.

In step S001, the diagnosing unit 130 acquires a diagnostic period corresponding to a diagnostic target machine ID and diagnostic model ID from the management table in the storage unit 120. Next, in step S002, the diagnosing unit 130 acquires, from the diagnostic model table in the storage unit 120, a used sensor and a sensor data corresponding to the diagnostic target diagnostic model ID. Next, in step S003, the diagnosing unit 130 acquires, from the sensor table in the storage unit 120, based on the diagnostic target machine ID, the data of the used sensor and the sensor for the condition division requirement acquired in step S002 in an amount of the diagnostic period acquired in step S001. Next, in step S004, the diagnosing unit 130 acquires, from the sensor table in the storage unit 120, condition division requirements of the diagnostic target diagnostic model ID and divides the condition based on the sensor data acquired in step S003. Specifically, in the case of the diagnostic model M001, within the diagnostic period (the diagnostic period from 2/28/2012 00:00:00 to 2/28/2012 23:59:59 in the management table of FIG. 3(c)), the diagnosing unit 130 extracts data of the sensors A, B, and C which have been used when the data of the sensor D is used as the condition division requirement being equal to or greater than 100. The data of used sensor which does not meet the condition division requirements is deleted or not used.

Next, in step S005, the diagnosing unit 130 extracts, from the diagnostic model table in the storage unit 120, standard data and determination requirements of the diagnostic target diagnostic model ID and determines the abnormality of the machine based on the diagnostic method. Next, in step S006, the diagnosing unit 130 stores the result of step S005 in a temporary storage area and ends the process.

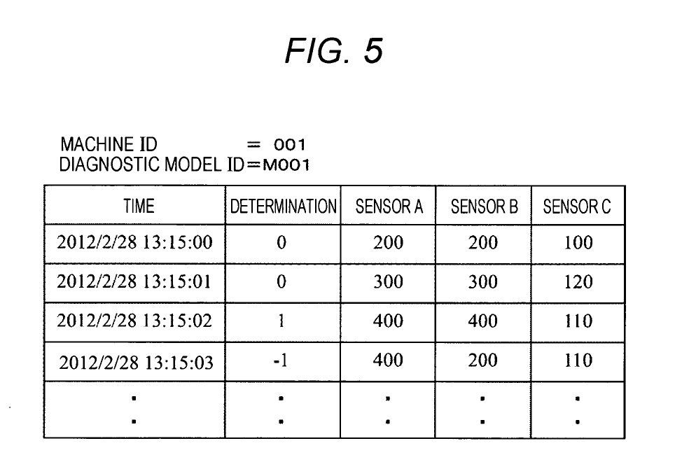

FIG. 5 illustrates a data format stored in the temporary storage area of step S006. A data format as shown in FIG. 5 is created for each machine ID and diagnostic model ID to be diagnosed. FIG. 5 illustrates the data format of diagnosis of the machine ID 001 and diagnostic model ID M001. The content of the data format of FIG. 5 is composed of determination results (denoted as “determination” in FIG. 5) corresponding to diagnostic target time and sensor data (sensor A, sensor B, and sensor C) used in the diagnosis. Further, the determination result and the sensor data are stored as a single record with respect to the time. Further, the determination result is composed of three types of data which are “1,” “0,” and “−1.” The determination result “1” is a result that it is determined as an abnormal state step S005. The determination result “0” in FIG. 5 is a result that it is determined as a normal state in step S005. The determination result “−1” in FIG. 5 indicates it is not included in the diagnostic target since the condition is divided in step S004 and the data does not belong to the time period to be input in step S005. Further, for the sensor data (sensor A, sensor B, and sensor C in FIG. 5) used in the diagnosis, the used sensor data in the diagnostic model table in the storage unit 120, which is acquired in step S002, is simply stored as it is. As described above, the processes in steps S001 to S006 are repeatedly executed for the single record in the management table in the storage unit 120.

The first distribution creation unit 140 creates frequency distribution (first frequency distribution) and probability distribution (first probability distribution) of all pieces of sensor data in the diagnostic period, for each machine and each diagnostic model.

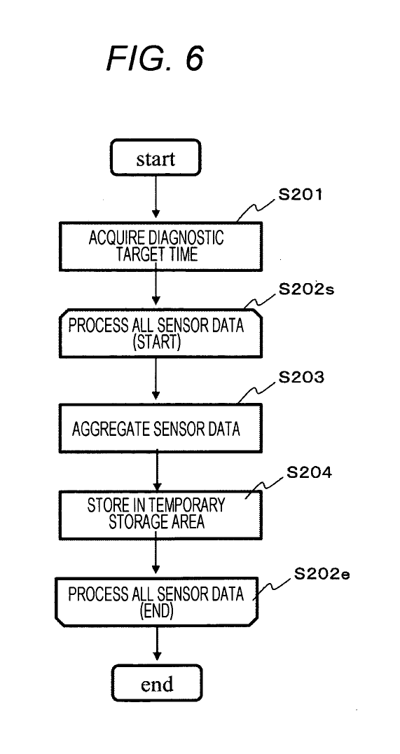

FIG. 6 illustrates a process flow of the first distribution creation unit 140.

In step S201, the first distribution creation unit 140 acquires, from the diagnosis (the data format of FIG. 5) output from the diagnosing unit 130, times when the diagnosis is “1” (an abnormal state) or “0” (a normal state). Here, the time when the diagnosis becomes “−1” is not acquired since the time is not included in the diagnostic target.

The processes of steps S203 and S204 between steps S202s and S202e are repeated until the process for all sensors stored in the sensor table of the diagnostic target machine ID in the storage unit 120 is finished.

In FIG. 6, the process flow that finishes the process of all sensors is ended. In step S203, the first distribution creation unit 140 acquires, from the sensor table in the storage unit 120, data of the time acquired in step S201 regarding the sensor selected in step S202s and aggregates the sensor data based on an aggregation unit which is previously determined according to performance of each sensor type.

The aggregation unit represents a width to divide the sensor data by a predetermined number. In every aggregation units, a frequency degree of data is aggregated. This aggregation result is the first frequency distribution. Further, an existence probability is calculated in every aggregation units. The probability is obtained by dividing the frequency of the aggregation unit with a total value of the frequency. This calculation result is the second probability distribution.

In step S204, the aggregated data is written to the temporary storage area.

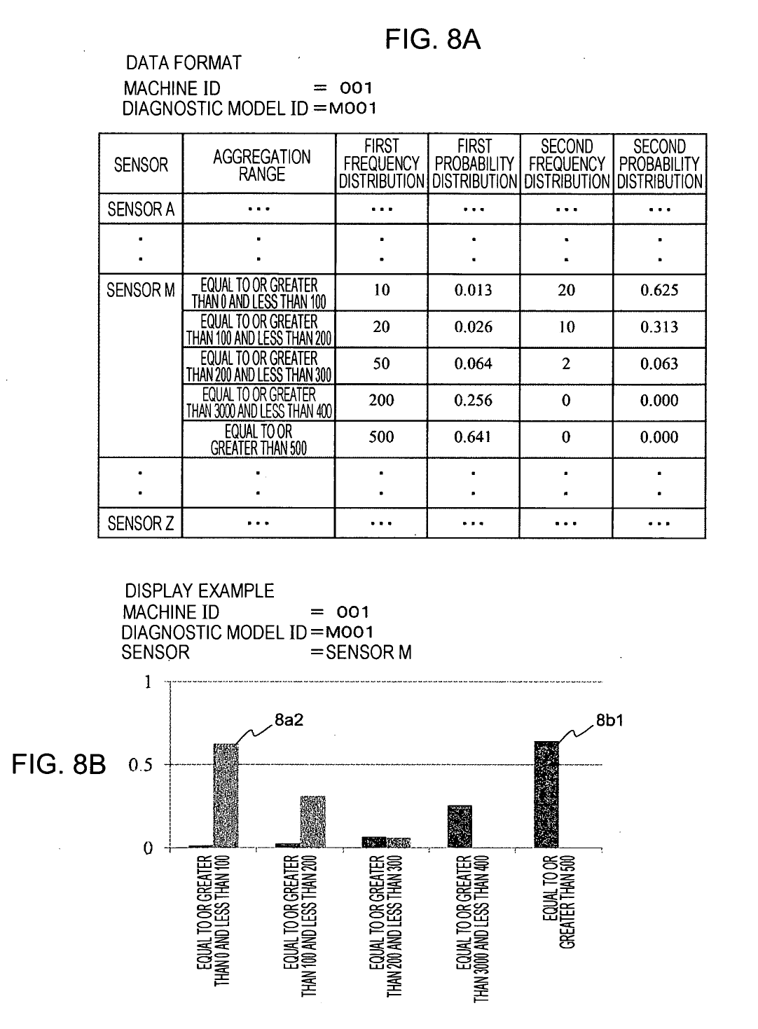

FIG. 8 (a) illustrates an example of the data format at this timing. The data format of FIG. 8 (a) is created for each machine ID and diagnostic model ID and has a format so that second distribution information can be written in addition to the first distribution. The listing of the sensor names in FIG. 8 (a) stores the names of the sensors which are already aggregated. This data format includes information of the first distribution and second distribution of all sensors in the sensor table in the storage unit 120. Then, in FIG. 8 (a), an aggregation result of the sensor M is stored. In the listing of the aggregation ranges, information of aggregation unit used in step S203 is stored. Here, five aggregation units are defined regarding sensor M. The respective aggregation units are “equal to or greater than 0 and less than 100,” “equal to or greater than 100 and less than 200,” “equal to or greater than 200 and less than 300,” “equal to or greater than 300 and less than 400,” and “equal to or greater than 500.” In the listing of the first distributions, information of the first frequency distribution and first probability distribution which are calculated in step S203 are stored. For example, regarding the first frequency distribution in FIG. 8 (a), the frequency “10” of the sensor M with the aggregation unit “equal to or greater than 0 and less than 100” indicates that there are ten pieces of data of the sensor M which are equal to or greater than 0 and less than 100. Further, this probability is 0.013 (=10/780).

The second distribution creation unit 150 creates, for each machine and each diagnostic model, frequency distribution (second frequency distribution) and probability distribution (second probability distribution) of all pieces of sensor data that have a determination result of “1” (abnormal state) in the diagnostic period.

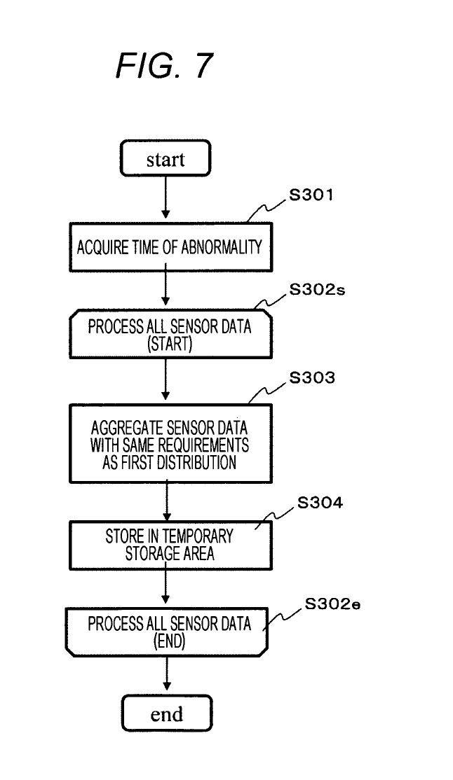

FIG. 7 illustrates a process flow of the second distribution creation unit 150.

In step S301, the second distribution creation unit 150 acquires time of the diagnosis of “1” (abnormal state) from the diagnosis (of the data format illustrated in FIG. 5) output from the diagnosing unit 130. Here, the time when the diagnosis is “−1,” is not included in the diagnostic target and not acquired. The processes in steps S303 and S304 between the steps S302s and S302e are repeated until the process for all sensors corresponding to the diagnostic target machine IDs in the sensor table in the storage unit 120 are finished. When the processes for all the sensors are finished, the process flow of FIG. 7 is ended.

In step S303, the second distribution creation unit 150 acquires, from the sensor table in the storage unit 120, data of the time acquired in step S301 regarding the sensor selected in step S302s and aggregates the sensor data with the aggregation unit of the first distribution aggregated in step S203. This aggregation result is the second frequency distribution. In step S304, the aggregated data is written to the listing of second distribution in the temporary storage area. For example, in the second frequency distribution in FIG. 8, the frequency “20” of the sensor M with the aggregation unit of “equal to or greater than 0 and less than 100” indicates that there are twenty pieces of data of the sensor M which are equal to or greater than 0 and less than 100 within the times of abnormal states. Further, the probability is 0.625 (=20/32). A total number of the frequency of the second frequency distribution is smaller than the total number of the first frequency distribution. This is because the second frequency distribution is an aggregation of the sensor data at the times of abnormal states.

FIG. 8(b) illustrates a graph that compares the first probability distribution and the second probability distribution to explain.

FIG. 8 (b) illustrates aggregation results of the sensor M in the case with the machine ID 001 and diagnostic model ID M001, where the horizontal axis represents aggregation units and the vertical axis represents probabilities. The graph 8b1 represents the first probability distribution and the graph 8a2 represents the second probability distribution.

When the diagnosis processed in step S301 is a false report, the second probability distribution represents a probability of an existence of a false report. Although there are two types of false reports which are one reported in a steady state and one reported in a transient state, it is here assumed that false reports are intensively reported in the transient state of the machine. Here, to divide the normal condition and the transient state, the first probability distribution and second probability distribution of all sensor data are considered. When the sensor data is not related to the transient state, the second probability distribution has the same distribution shape with the first probability distribution. On the other hand, when the sensor data is related to the transient state, the second probability distribution and the first probability distribution have different distribution shapes. With the greater difference is seen, the sensor is more likely to be applicable as a sensor to divide the normal condition and the transient state (the sensor for the condition division requirements). In FIG. 8(b), since the first distribution and the second distribution have different shapes, the sensor M is likely to be used as a sensor for the condition division requirements. The determination of whether the diagnosis is a false report or not is executed on the display unit 170 by the supervisor 2.

The priority order calculation unit 160 calculates the degree of difference between the first distribution and second distribution as goodness of fit, and sets priority orders of the sensors in descending order of goodness of fit. This process is executed for each machine and each diagnostic model.

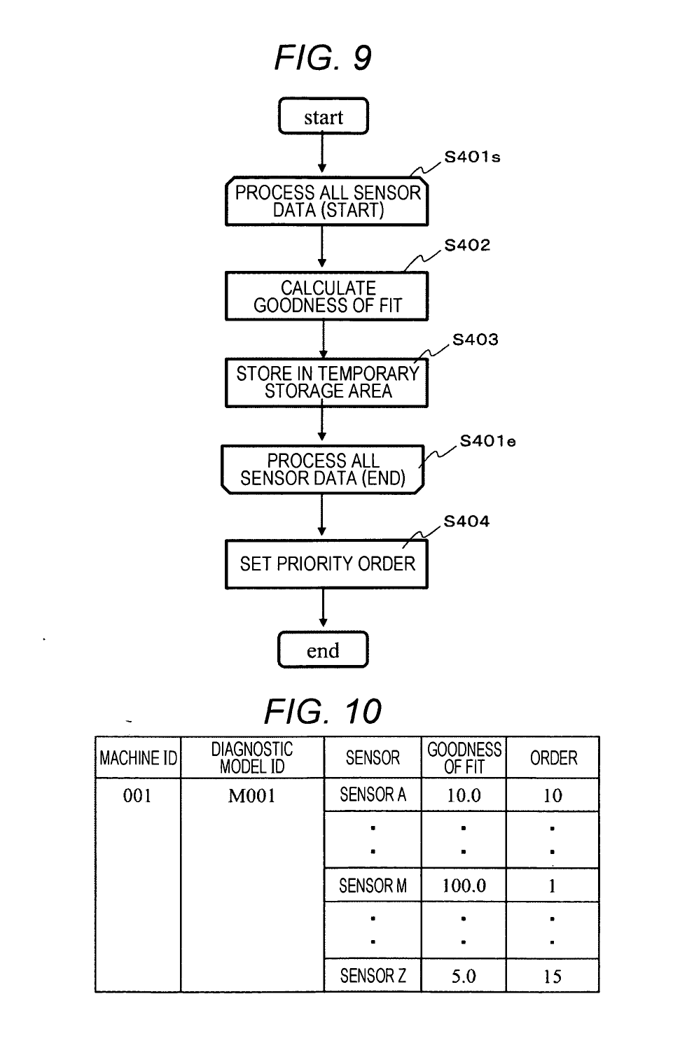

FIG. 9 illustrates a process flow of the priority order calculation unit 160. The processes in steps S402 and S403 between steps S401s and S401e are repeated for all the sensors. Here, the all sensors are the all sensors stored in the data format of FIG. 8(a). Step S402 calculates goodness of fit of the first distribution and second distribution in the data format of FIG. 8(a). A probability of the first probability. distribution of the “k”th aggregation unit is denoted by P1k and frequency of the second probability distribution is denoted by E2k. Further, the sum of the second frequency distribution, that is, the number of cases that is determined as an abnormal state is denoted as M(=ΣE2k). An expected value of frequency of the “k”th aggregation unit of the first frequency distribution when assuming the number of abnormalities M can be expressed as E1k (=M×P1k). By using the difference between E1k and E2k, the goodness of fit Z is calculated by the following expression. “Σ” represents a sum of the all aggregation units k.

Z=Σ((E2k−E1k)̂2/E1k)

When the first probability distribution and the second probability distribution are more similar to each other, the goodness of fit becomes closer to zero and, when the first probability distribution and the second probability distribution are more different, the goodness of fit becomes greater. In step S403, the calculated goodness of fit is written in the data format in the temporary storage area.

FIG. 10 illustrates an example of the data format. In the listings of machine IDs and diagnostic model IDs in the data format of FIG. 10, the machine ID and diagnostic model ID which are used as the targets of the calculation by the priority order calculation unit 160 are stored. Further, the listing of sensors, the names of the sensors (sensor A to sensor Z in this example) which are processed in step S401s are stored. Further, in the listing of goodness of fit, goodness of fit values calculated in step S402 are stored. Further, in the listing of orders, the result processed in step S404 is stored. In step S404, the priority order calculation unit 160 refers to goodness of fit of all sensors in the data format in FIG. 10 and sets priority order in descending order of goodness of fit. For example, in the example of FIG. 10, since the sensor M has the greatest goodness of fit, its priority order is set as one. When the orders for all sensors are set, the process is ended.

The display unit 170 is composed of a screen 1 for showing a diagnosis to the supervisor 2, a screen 2 for updating a diagnostic model, and a screen 3 for supporting to set condition division requirements in diagnostic model update.

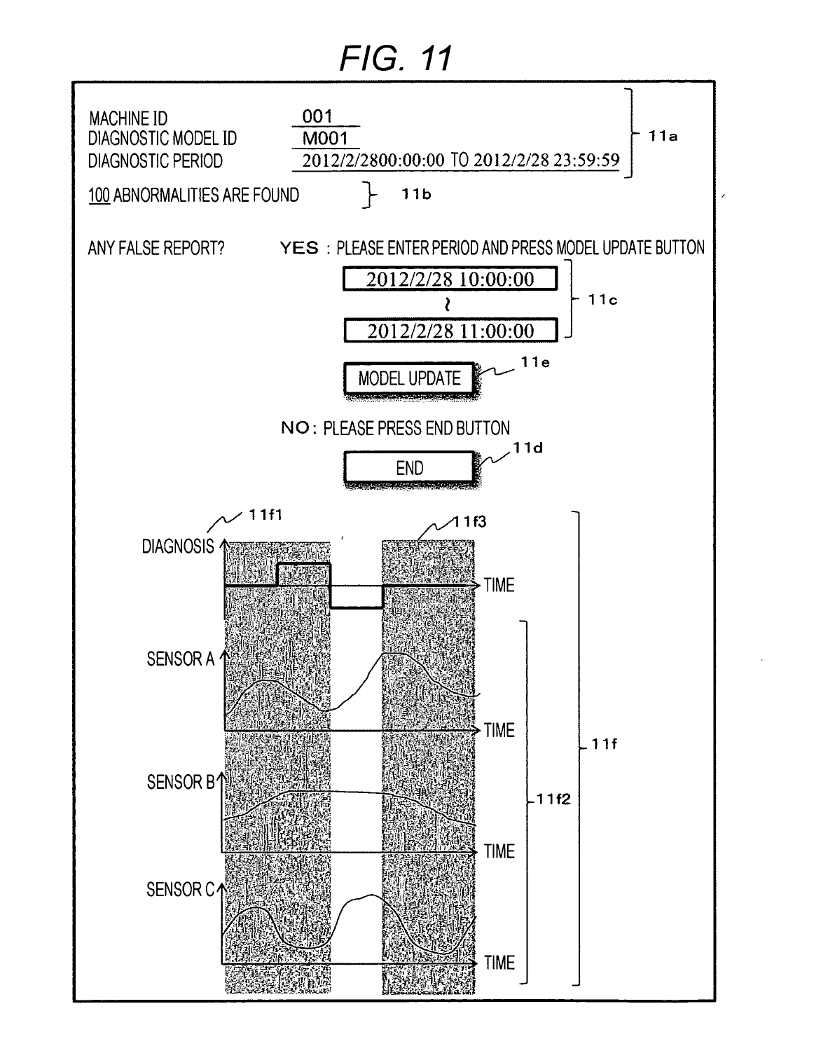

Firstly, an example of the screen 1 of the display unit 170 will be explained. The screen 1 is a screen for showing a diagnosis to the supervisor 2. Further, when the supervisor 2 determines that there are many false reports in the diagnosis based on the machine running information and information from the field, a period in which the false reports are made is input and the screen is changed to the screen 2 for updating diagnostic model. FIG. 11 illustrates an example of the screen 1. Display data 11a displays a diagnosis period, a diagnostic model ID, and a machine ID. In the example of FIG. 11, “machine ID 001” and “diagnostic model ID M001” are displayed. Further, display data 11b displays a value of the counted number of the diagnoses of “1” stored in the data format of FIG. 5. In the example of FIG. 11, the number of abnormality cases is 100. Trend data 11f expresses a diagnosis stored in the data format of FIG. 5 and a used sensor which is used in the diagnosis. The graph 11f1 placed at the top of the trend data 11f is a graph of diagnoses of “1,” “0,” and “−1” which are expressed by time. Other graphs 11f2 are trend data of the used sensors. In the example of FIG. 11, trend data of the sensor A, sensor B, and sensor C are illustrated. A hatched part 11f3 of the trend data 11f2 is a time range extracted based on the condition division requirements. In the example of FIG. 11, since the condition division requirements define that the data of the sensor D being equal to or greater than 100, the time range of the data of the sensor D being equal to or greater than 100 is highlighted as a diagnosed time range. Whether or not to hatch is determined based on whether the diagnosis at the same time in the data format of FIG. 5 is 0 or 1. When the diagnosis is 0 or 1, since it is within the diagnostic target period, the target time in the graph of the trend data is highlighted by hatching. With this, the supervisor 2 can visually confirm the diagnostic target time range. The display data 11c is a box used, when the supervisor 2 determines that there is a false report in the diagnostic period, to input the corresponding period (false report period). When a false report period is input, a button lie is displayed. In display data 11c of FIG. 11, a period from 2/28/2012 10:00:00 to 2/28/2012 11:00:00 is input as a false report period by the supervisor 2. To update the diagnostic model, the button lie is pressed and the screen is changed to the screen 2. When the supervisor determines that there is no false report, when the diagnostic model is not updated, or when the diagnosis is confirmed, a button 11d is pressed to close the screen.

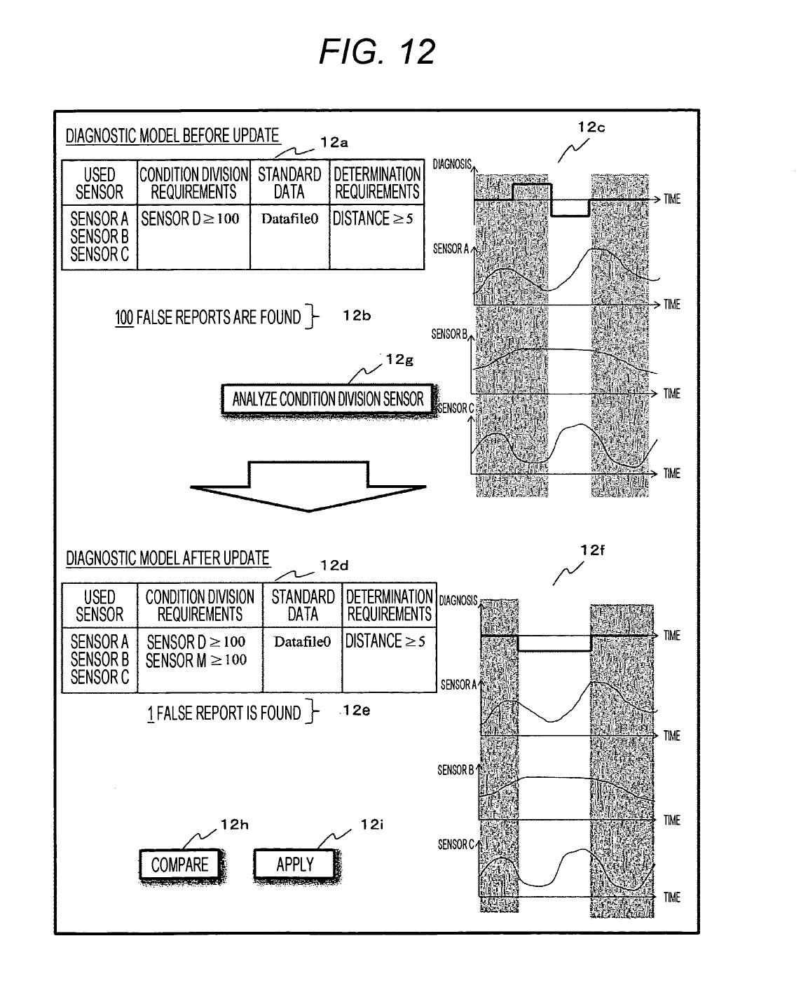

FIG. 12 illustrates an example of the screen 2. The screen 2 is a screen to support the supervisor 2 to update the diagnostic model. The screen 2 has an upper part and a lower part, the upper part shows a diagnostic model before update and the lower part shows the diagnostic model after update. Display data 12a shows the content of the diagnostic model ID M001 in the diagnostic model table of the storage unit 120, which is used by the diagnosing unit 130. On the other hand, display data 12d shows a diagnostic model after update. The supervisor 2 can directly input the display data 12d. Firstly, the content of the diagnostic model of the display data 12a is copied and then the content is modified as referring to the display data 12a. Display data 12b shows the number of abnormality cases of the display data 11b in the false report period which is input on the screen 1 as a number of false reports. Display data 12c shows the display data 11f of the screen 1. Display data 12e shows the number of false reports of the updated diagnostic model. The update of the display of the display data 12e is executed when a button 12h is pressed. Specifically, when the information of the updated diagnostic model (illustrated in the display data 12d) is input to the comparison unit 180, the number of false reports of the updated diagnostic model is shown. The updated diagnostic model of FIG. 12 is a model in which a requirement that the data of the sensor M is equal to or greater than 100 is added to the condition division requirements of the diagnostic model before update. Further, a trend of the corresponding diagnosis and used sensor is shown as trend data 12f. Similarly to the trend data 11f of the screen 1, the trend data 12f also shows as highlighting the condition division time range. The trend data 12f highlights a time range in which the data of the sensor D is equal to or greater than 100 and the data of the sensor M is equal to or greater than 100. When a button 12g is pressed, the screen 3 is displayed. When a button 12i is pressed, the updated diagnostic model is selected as a new diagnostic model. The information of the newly selected diagnostic model is provided to the update unit 190. As described above, on the screen 2, operation to update the diagnostic model can be performed as referring to the diagnostic model before update.

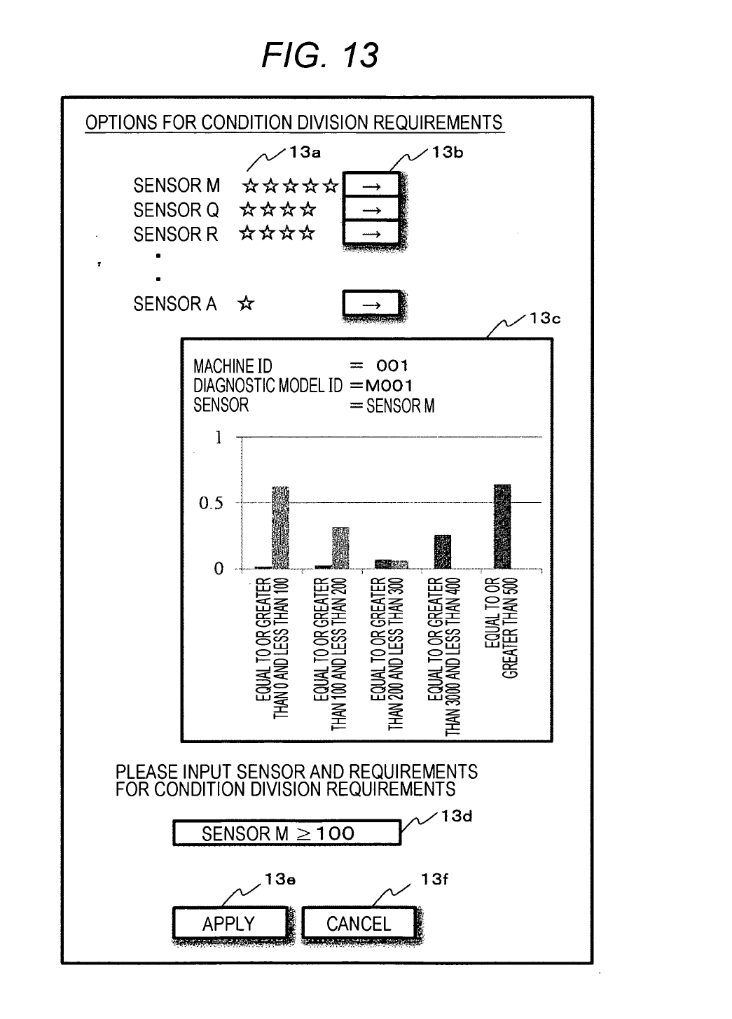

FIG. 13 illustrates an example of the screen 3. The screen 3 is a screen for supporting to set condition division requirements. Display data 13a shows a list of the sensors in descending order of priority order of sensor data in the data format of FIG. 10. Since the level of goodness of fit is displayed with stars, options of sensors for the condition division requirements can be visually shown.

In FIG. 13, since the sensor M is a sensor having a greatest goodness of fit, the sensor M is shown in the top of the display data 13a. Display data 13b is a button to show a screen 13c for comparing the first distribution and second distribution of the sensor. FIG. 13 illustrates a case that the button 13b of the sensor M is pressed, and the comparison screen 13c shows a comparison state of the sensor M. This distribution is displayed using the items of the first probability distribution and the second probability distribution in the data format of FIG. 8(a). Display data 13d is a window to input a condition division requirement. The condition division requirement is manually input by the supervisor 2 as confirming the display data 13a and 13c. FIG. 13 illustrates a case that the supervisor 2 has input a requirement of the sensor M being equal to or greater than 100. When the button 13e is pressed, the input condition division requirement is applied to the diagnostic model after update in the display data 12d of the screen 2 and the display returns to the screen 2. Here, a requirement of the data of the sensor M being equal to or greater than 100 is added to the condition division requirements. A button 13f indicates cancellation and has a function to return to the screen 2 without doing anything.

The comparison unit 180 calculates the number of false reports of the diagnostic model after update to compare the numbers of the false reports of the diagnostic models before and after the update on the screen 2.

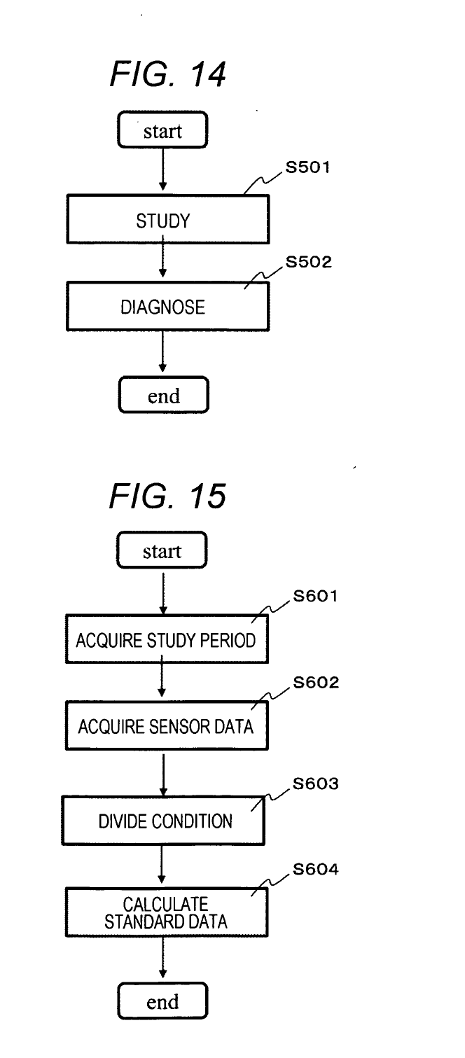

FIG. 14 illustrates a process flow of the comparison unit 180. In step S501, the comparison unit 180 provides information of the diagnostic model after update to the study unit 200 and calculates standard data of the diagnostic model. The details will be described later. In step S502, the diagnosing unit 130 diagnoses by using the standard data calculated in step S501 and the diagnostic model after update. The diagnostic result is stored, in the same format as the data format of FIG. 5, to the temporary storage area and provided to the screen 2 of the display unit 170.

The update unit 190 has a function to create new standard data of the diagnostic model with the new diagnostic model received from the screen 2 and the study unit 200 and update the used sensor, condition division requirements, determination requirements, and standard data of the diagnostic model of the corresponding diagnostic model ID in the diagnostic model table of the storage unit 120.

The study unit 200 creates standard data of the new diagnostic model acquired from the comparison unit 180 or the update unit 190. When acquired from the comparison unit 180, the standard data is provided to the comparison unit 180. Further, when acquired from the update unit 190, the standard data is provided to the update unit 190.

FIG. 15 illustrates a process flow of the study unit 200. In step S601, the study unit 200 acquires a study period of a corresponding new target model in the management table of the storage unit 120. Next, step S602 acquires data which is the sensor data of a used sensor of the new diagnostic model and the study period acquired in step S601, from the sensor table of the corresponding machine ID in the storage unit 120. Next, in step S603, a condition division of the new diagnostic model is executed. In this process, by using the sensor and requirement of the condition division requirement, data of the used sensor at the same time that meets the requirement is extracted, similarly to step S004 in FIG. 4. Next, in step S604, based on the employed diagnostic method, standard data is calculated and provided to the comparison unit 180 or the update unit 190.

### Second Embodiment

The above described priority order calculation unit 160 can also acquire a sensor and a requirement of condition division requirements by using accumulated error rates of each aggregation unit of the first distribution and second distribution. With this, the supervisor 2 does not have to directly and manually input to set requirements of the sensor in the screen 3 and, when options for the sensors and requirements of the condition division acquired by the priority order calculation unit 160 are shown so that the supervisor 2 can select from them, this can reduce dependence on technical knowledge of the supervisor 2.

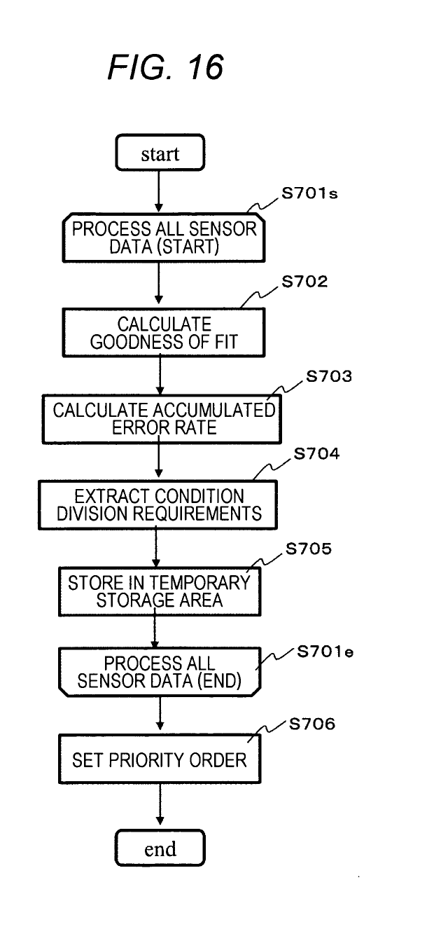

FIG. 16 illustrates a process flow of the priority order calculation unit 160. Steps S702 to S705 between steps S701s and S701e execute processes for the sensor of a target machine included in the sensor table of the storage unit 120. When the processes for all the sensors are finished, the process proceeds to step S706. In step S702, the priority order calculation unit 160 calculates goodness of fit with a method same as that in step S402 in FIG. 9. Next, step S703 calculates accumulated error rates of sensors in ascending order of the values. Specifically, here, an accumulated error based on the goodness of fit obtained in step 702 is calculated. An accumulated error rate Rk of the “k”th aggregation unit can be obtained with the following expression:

Rk=Σ((E2k−E1k)̂2/E1k)/Z

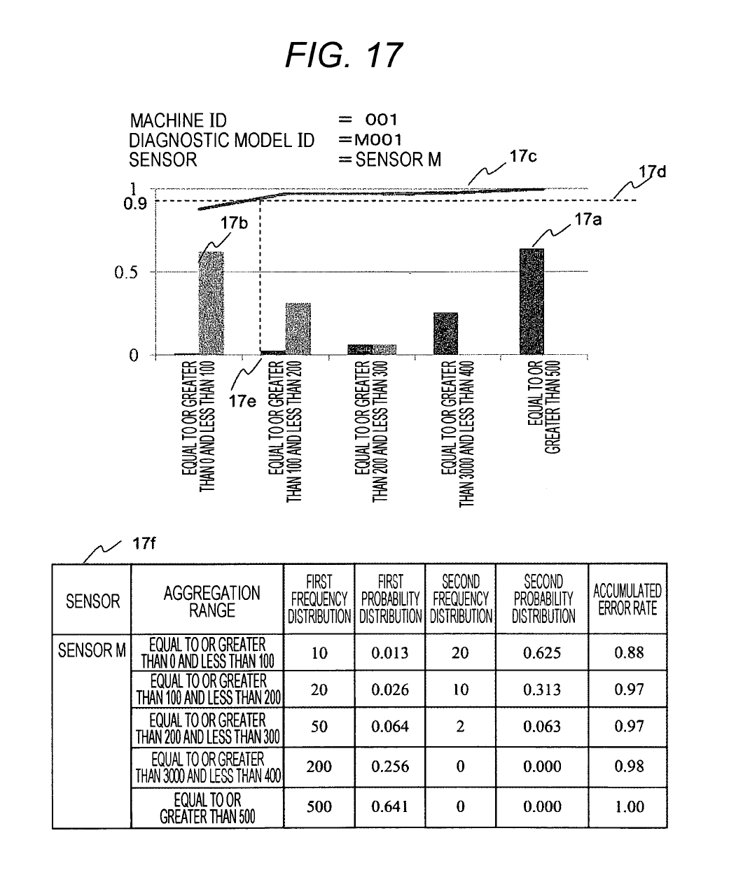

“Σ” is a sum of the first to the “k”th. This is a value that the sum of goodness of fit of the first to “k”th aggregation units divided by the goodness of fit obtained in step S702. FIG. 17 illustrates an example of the first probability distribution and the second probability distribution to which the accumulated error rate is applied (the machine 001, and the sensor M of the diagnostic model M001). The graph 17a illustrates the first probability distribution, the graph 17b illustrates the second probability distribution, and the graph 17c illustrates the accumulated error rates. Based on the graph of the accumulated error rates, a sensor value with which a difference between the first probability distribution and second probability distribution is likely to be generated can be presumed. Next, step S704 here uses a threshold value, 0.9 for example, of an accumulated error rate which is previously set based on reliability of the sensor and extracts a value corresponding to the aggregation unit having an accumulated error rate greater than 0.9 as a condition division requirement. The boundary line 17d indicates a border of the accumulated error rate 0.9 and the sensor vale 17e corresponding to the accumulated error rate 0.9 is employed as a threshold value of condition division requirements (here, the data of the sensor M being equal to or greater than 100). The chart 17f illustrates original data of the accumulated error rate graph and the accumulated error rates are stored. Next, step S705 writes results of steps S702 to S704 to the temporary storage area.

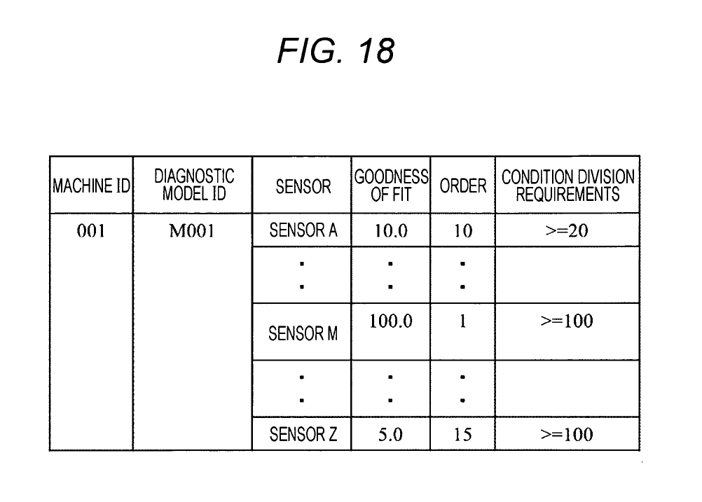

FIG. 18 illustrates an example of the data format to be written in the above case. In the data format of FIG. 18, compared to the data format of FIG. 8, a listing of condition division requirements extracted in step S704 is added. In step S706, priority orders are set according to the listing of goodness of fit in the data format of FIG. 18. This process is the same process in step S404 of FIG. 9.

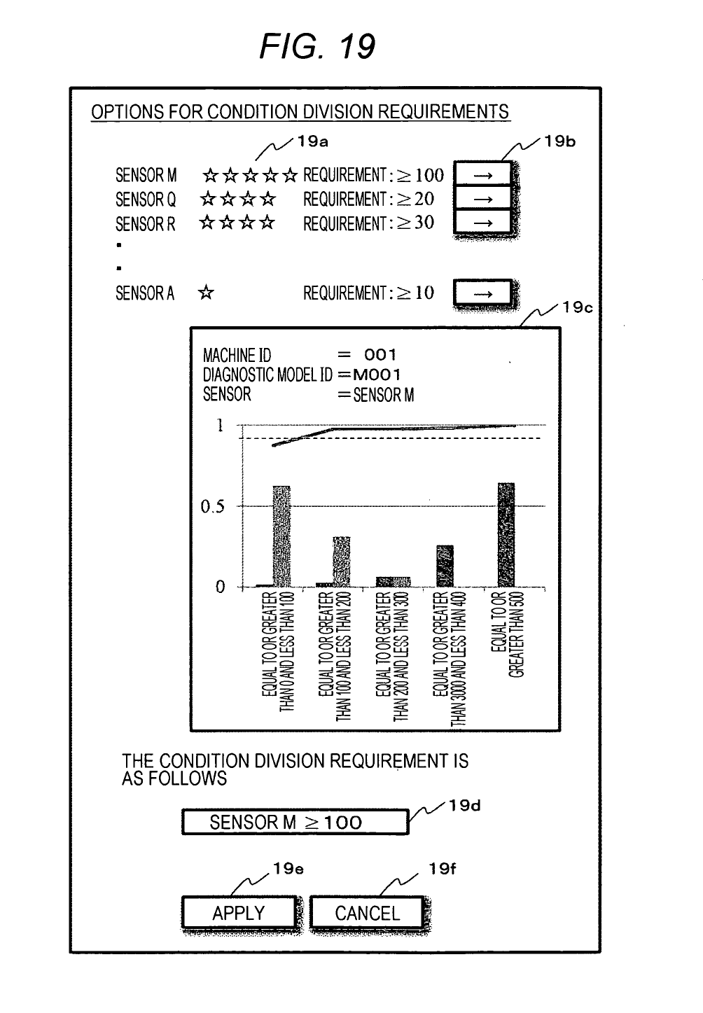

FIG. 19 further illustrates an example of the screen 3 of the display unit 170 where the priority order calculation unit 160 is used.

The difference from the example of the screen 3 of FIG. 13 is that the threshold values of the condition division requirements which are obtained by the priority order calculation unit 160 are shown in the display data 19a (corresponding to 13a in FIG. 13). Further, the supervisor 2 selects, from the sensor list 19a, a sensor and requirement for a condition division which seems to be the most desirable. When this sensor selection is made, the selected sensor name and requirement for condition division are simply applied to the condition division requirement input screen 19d (corresponding to 13d in FIG. 13).

FIG. 19 illustrates a case that the sensor M is selected. Thus, in 19d, a requirement that the data of the sensor M is equal to or greater than 100 is automatically input. Further, when the button 19b of each sensor is pressed, the graph 19c is shown. The graph 19c is a graph illustrated in above described FIG. 17, to which a cumulative contribution rate is also added. The buttons 19e and 19f in FIG. 19 have functions same as those of the buttons 13e and 13f in FIG. 13.

As described above, the following advantageous effects can be brought about according to the above described embodiments. Described specifically, since the condition monitoring apparatus 100 displays as comparing the frequency distribution (first distribution) of sensor data of a machine with frequency distribution (second distribution) of sensor data of the machine in an abnormal condition, options of sensors appropriate for condition division requirements can be narrowed down. This helps to reduce dependence on technical knowledge related to the machine and improves the accuracy of diagnoses.

It is noted that the above described embodiments are illustrative for the description of the invention and is not intended to limit the scope of the present invention to the embodiments only. Those skilled in the art can carry out the present invention in various other embodiments without departing from the gist of the present invention.

### Third Embodiment

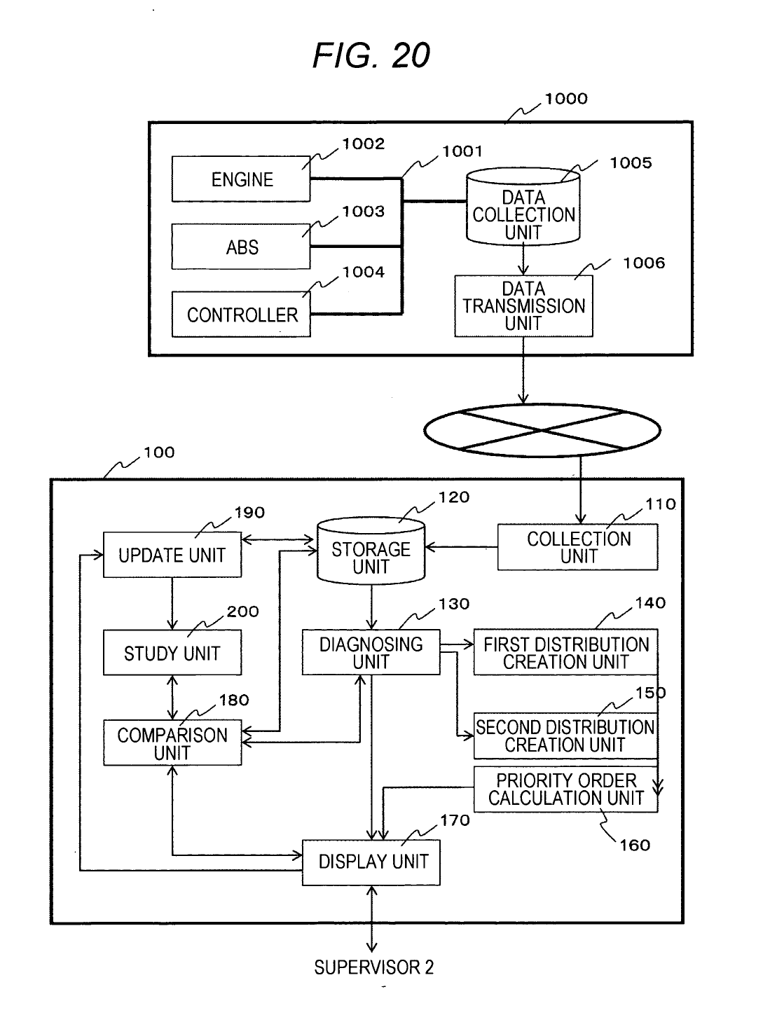

As a modification example of the embodiments, a vehicle 1000 is assumed as the machine 1. FIG. 20 illustrates outlines of a vehicular CAN network and the condition monitoring apparatus 1000. CAN is a controller area network which is a network standard for connecting electronic circuits and various devices in a machine. In the CAN network, control information of devices connected to the network and sensor data information are transmitted.

To the CAN network 1001 of the vehicle 1000 of FIG. 20, an engine 1002, an ABS 1003, a controller 1004, and a data collection unit 1005 are connected. It is not illustrated here but many devices and controllers are connected to the actual vehicular CAN network.

The engine 1002 transmits information of a sensor attached to the engine to the controller 1004 via the CAN network.

The ABS 1003 is an anti-lock braking system and activates the anti-lock braking system when an instruction to activate the anti-lock braking system is received from the controller 1004 via the CAN network. The controller 1004 receives sensor data from other devices and control information from other unillustrated controllers. The vehicle is controlled by more than one controllers.

The data collection unit 1005 collects control information and information of sensor data transmitted in the CAN network 1001 at a predetermined timing and accumulates the data for a certain period of time. The collected data is transmitted to the condition monitoring apparatus 100 via a data transmission unit 1006. The data transmission unit 1006 and the collection unit 110 of the condition monitoring apparatus 100 are connected via a wired or wireless communication system (not shown). When a case to diagnose an engine trouble is considered, the used sensors in the diagnostic model table of FIG. 3(b) are an engine speed sensor (corresponding to the sensor A), an engine exhaust gas temperature sensor (corresponding to the sensor B), and a fuel consumption sensor (corresponding to the sensor C). Further, the sensor for condition division requirements is an engine oil temperature sensor (corresponding to the sensor D) or an engine coolant temperature sensor (corresponding to the sensor M of the diagnostic model after update in FIG. 12).

It is to be noted that the above described modification example of the embodiments is illustrative for the description of the present invention and is not intended to limit the scope of the present invention to the condition monitoring of a vehicular engine only.

### Fourth Embodiment

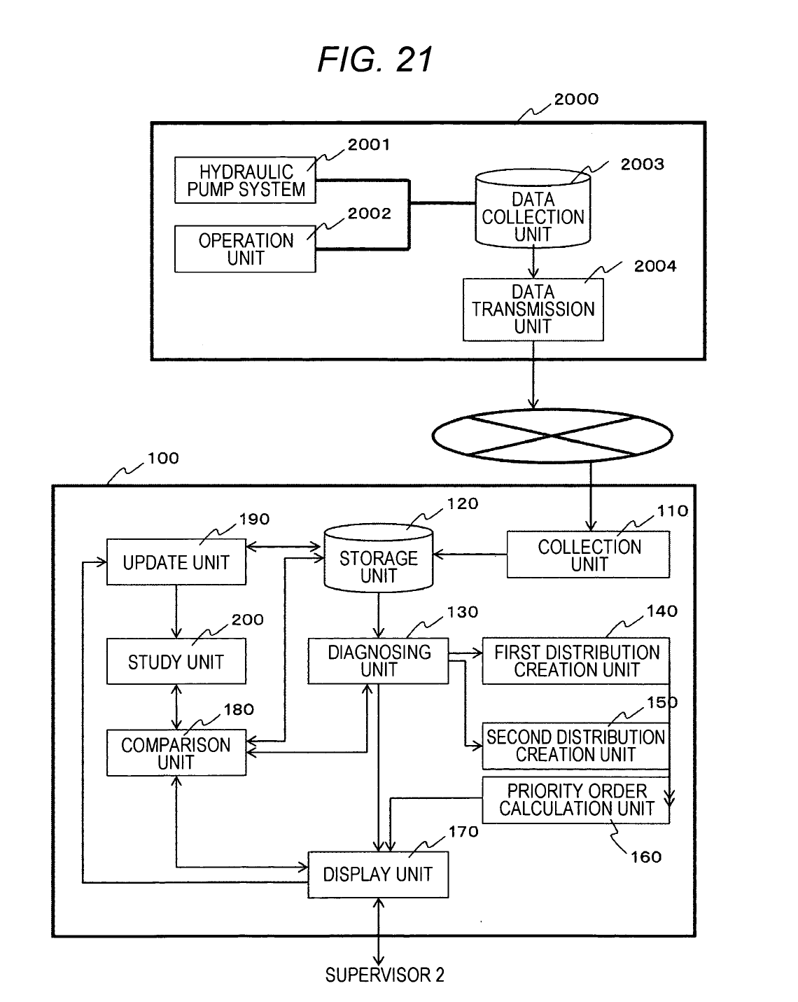

As a modification example of the embodiments, a machine that uses a hydraulic pump (for example, a construction machine) is assumed as the machine 1. FIG. 21 illustrates outlines of a construction machine 2000 and the condition monitoring apparatus 100. The construction machine 2000 has a hydraulic pump system 2001, an operation unit 2002, a data collection unit 2003, and a data transmission unit 2004. The devices are connected via a wired network. The construction machine 2000 includes more than one unillustrated devices in addition to the hydraulic pump system 2001 and the operation unit 2002.

The hydraulic pump system 2001 is controlled according to a command value input from the operation unit 2002. Further, the hydraulic pump system 2001 periodically transmits information of a sensor attached to the hydraulic pump system 2001 to the data collection unit 2003. The specific information of the sensor may be a pump pressure value and an oil temperature in the pump.

The operation unit 2002 converts information input by an operator of the construction machine 2000 into a command value and transmits to each device.

The data collection unit 2003 collects information of devices mounted in the construction machine 2000 at a predetermined timing and accumulates the data for a certain period of time. The collected data is transmitted to the condition monitoring apparatus 100 via the data transmission unit 2004. The data transmission unit 2004 and the collection unit 110 of the condition monitoring apparatus 100 are connected via a wired or wireless communication system (not shown).

Considering a case to diagnose a failure of a hydraulic pump system including more than one hydraulic pumps, the used sensors of the diagnostic model table in FIG. 3(b) are a first hydraulic pump pressure value sensor (corresponding to the sensor A), a second hydraulic pump pressure value sensor (corresponding to the sensor B), and a third hydraulic pump pressure value sensor (corresponding to the sensor C). Further, the sensors for the condition division requirements are a hydraulic pump oil temperature sensor (corresponding to the sensor D) and a command value from the operation unit 2002 that activates the hydraulic pump (corresponding to the sensor M of the diagnostic model after updated in FIG. 12).

It is to be noted that the above described modification example of the embodiments is illustrative for the description of the present invention and is not intended to limit the scope of the present invention to the condition monitoring of a hydraulic pump system only.

### Fifth Embodiment

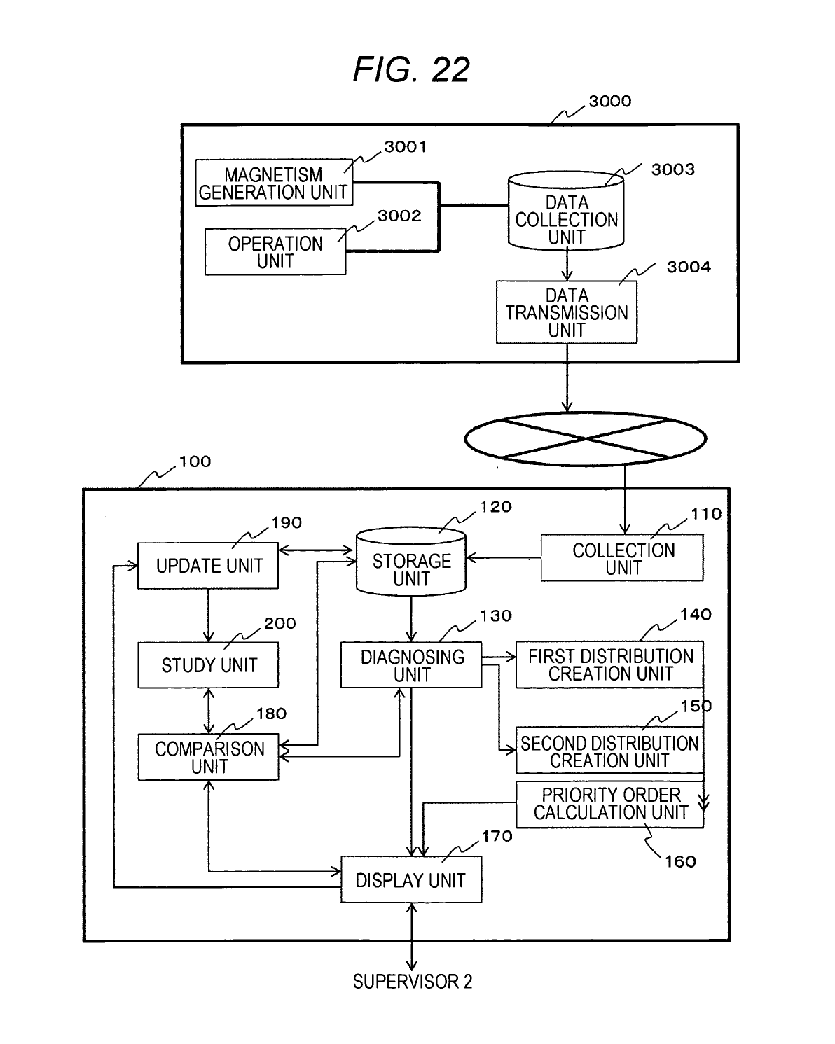

As a modification example of the embodiments, medical equipment 3000 is assumed as the machine 1. FIG. 22 illustrates outlines of the medical equipment 3000 and the condition monitoring apparatus 100. As the medical equipment 3000 here, for example, there is an MRI device. The MRI device is a device for applying magnetism to a human body and capturing an image.

The medical equipment 3000 has a magnetism generation unit 3001, an operation unit 3002, a data collection unit 3003, and a data transmission unit 3004. The devices are connected via a wired network. The medical equipment 3000 includes more than one unillustrated devices in addition to the magnetism generation unit 3001 and the operation unit 3002.

The magnetism generation unit 3001 is controlled by a command value input from the operation unit 3002. Further, the magnetism generation unit 3001 includes a sensor that measures the strength of magnetism and a vibration sensor that measures vibration of the magnetism generation unit. The magnetism generation unit 3001 transmits the information of the sensors to the data collection unit 3003.

The operation unit 3002 converts information input by an operator of the medical equipment 3000 into a command value and transmits the value to each device.

The data collection unit 3003 collects information of the devices mounted in the medical equipment 3000 at a predetermined timing and accumulates the data for a certain period of time. The collected data is transmitted to the condition monitoring apparatus 100 via the data transmission unit 3004. The data transmission unit 3004 and the collection unit 110 of the condition monitoring apparatus 100 are connected via a wired or wireless communication system (not shown).

Considering a case to diagnose a failure of the medical equipment 3000, the used sensors in the diagnostic model table of FIG. 3 (b) are the magnetism sensor that detects the strength of magnetism (corresponding to the sensor A), the vibration sensor that detects a vibration amplitude of the measured vibration (corresponding to the sensor B), and a vibration sensor that detects a specific frequency band for obtaining the strength of the specific frequency band of the measured vibration data (corresponding to the sensor C). Further, the sensors for condition division requirements are the magnetism sensor that detects the strength of magnetism (corresponding to the sensor D) and the command value from the operation unit 2002 that activates the medical equipment 3000 (corresponding to the sensor M of the diagnostic model after update in FIG. 12).

It is noted that the above described modification example of the embodiment is illustrative for the description of the present invention and is not intended to limit the scope of the present invention to the condition monitoring of a medical equipment only.

### INDUSTRIAL APPLICABILITY

According to the present invention, since the frequency distribution (first distribution) of the sensor data of the machine and the frequency distribution (second distribution) of the sensor data of the machine in an abnormal condition are displayed in comparison, options of sensors that are appropriate for condition division requirements of a diagnostic model can be narrowed down and this helps to improve the general accuracy of a machine diagnosis.

### REFERENCE SIGNS LIST

1 machine
2 supervisor
3 operator
100 condition monitoring apparatus
110 collection unit
120 storage unit
130 diagnosing unit
140 first distribution creation unit
150 second distribution creation unit
160 priority order calculation unit
170 display unit
180 comparison unit
190 update unit
200 study unit
1000 vehicle
1001 CAN network
1002 engine
1003 ABS
1004 controller
1005 data collection unit
1005 data transmission unit
2000 construction machine
2001 hydraulic pump system
2002 operation unit
2003 data collection unit
2004 data transmission unit
3000 medical equipment
3002 operation unit
3003 data collection unit
3004 data transmission unit

1. A condition monitoring apparatus that diagnoses an abnormal state of a machine based on operation data of the machine acquired via a plurality of sensors, the condition monitoring apparatus comprising:
a data collection unit configured to collect data from the plurality of sensor data of the machine;
a diagnosing unit configured to acquire a sensor data group from the sensor data and a diagnostic model from a data storage unit that stores a diagnostic model that is a requirement to diagnose an abnormal state of the machine, and diagnose the abnormal state of the diagnosed machine based on the diagnostic model;
a first distribution creation unit configured to create first distribution that is data frequency of each sensor based on the sensor data group aggregated with the total number of bins or a width which is previously set according to the machine performance;
a second distribution creation unit configured to extract sensor data from the sensor data group at a time when the diagnosing unit diagnoses the abnormal state and create second distribution that is frequency of extracted data of each sensor aggregated with the total number of bins or width which is same as that of the first distribution;
a display unit configured to display, on a screen, the first distribution and the second distribution of each sensor;
an input unit to which a user inputs a new diagnostic model; and
an update unit configured to write the new diagnostic model to the data storage unit.

2. The condition monitoring apparatus according to claim 1, wherein the diagnostic model includes a sensor group used to diagnoses, an diagnostic algorithm to be used, a condition division requirement including sensor data for extracting a condition of the diagnostic target machine and a threshold value requirement of the sensor data, and a determination requirement that is a threshold value as an index to express an abnormal state level calculated by the diagnostic algorithm.

3. The condition monitoring apparatus according to claim 2,
further comprising a preprocessing unit for display configured to calculate a degree of difference between the first distribution and the second distribution for each sensor and set priority orders of the sensors in descending order of the degree of difference,
wherein the display unit displays sensor names or the first distribution and the second distribution in order of the priority.

4. The condition monitoring apparatus according to claim 3, wherein
The preprocessing unit for display calculates a difference between the first distribution and the second distribution of each bin and calculates accumulated error rates in ascending order or descending order of the value corresponding to the bin, and
the display unit displays the accumulated error rates with the first distribution and the second distribution.

5. The condition monitoring apparatus according to claim 3, wherein the preprocessing unit for display calculates a difference between the first distribution and the second distribution of each bin, calculates accumulated error rates in ascending order or descending order of the value corresponding to the bin, compares the accumulated error rates with a requirement which is previously set according to sensor performance, sets the condition division requirement of the new diagnostic model based on the value corresponding to the bin corresponding to the requirement, and displays, on the display unit, the condition division requirement.

6. The condition monitoring apparatus according to claim 5, wherein the display unit displays the time-series data of the sensors and highlights a part corresponding to the condition division requirement calculated by the preprocessing unit for display.

7. The condition monitoring apparatus according to claim 5, wherein the display unit displays a diagnosis by the diagnosing unit where the condition division requirement calculated by the preprocessing unit for display is applied as the new diagnostic model.

8. The condition monitoring apparatus according to claim 2, wherein the display unit displays time-series data of the sensors and highlights a part corresponding to the condition division requirement of the new diagnostic model which is input by the input unit.

9. The condition monitoring apparatus according to claim 2, wherein the display unit displays the diagnosis by the diagnosing unit where the new diagnostic model input by the input unit is applied.
